(19) United States
(12) Patent Application Publication
(10) Pub. No.: US 2002/0180871 A1
(43) Pub. Date: Dec. 5, 2002

(54) Image shooting system

(75) Inventors: Kazuhiro Shibatani, Sakai-Shi (JP); Masayuki Ueyama, Takarazuka-Shi (JP); Satoshi Himeda, Amagasaki-Shi (JP)

Correspondence Address: SIDLEY AUSTIN BROWN & WOOD LLP, 717 NORTH HARWOOD, SUITE 3400, DALLAS, TX, 75201, US

(73) Assignee: MINOLTA CO., LTD.

(21) Appl. No.: 10/156,564

(22) Filed: May 28, 2002

(30) Foreign Application Priority Data
May 30, 2001 (JP) 2001-162581

(51) Int. Cl. H04N 5/232

(52) U.S. Cl. 348/211.99

(57) ABSTRACT

When image data is transmitted from an image shooting apparatus to an operation apparatus, the shooting time at which image shooting is performed (index information) is transmitted together with the image data. Receiving the image data, the operation apparatus performs image display based on the image data. While visually confirming the image displayed on the operation apparatus, the user inputs an operation command such as image recording when a desired image is displayed. Consequently, the operation apparatus generates a command corresponding to the operation command. Then, the operation apparatus transmits the received shooting time together with the image data to be displayed and the command to the image shooting apparatus. Receiving the command, the image shooting apparatus identifies the image data which the command is issued for, and appropriately executes the command.

This application is based on the application No. 2001-162581 filed in Japan, the content of which is hereby incorporated by reference.

### BACKGROUND OF THE INVENTION

1. Field of the Invention

The present invention relates to a technology to control an image shooting apparatus through a remote operation.

2. Description of the Related Art

An image shooting system has previously been known in which images are taken by remotely operating an image shooting apparatus such as a digital camera from an operation apparatus such as a portable telephone. In the conventional image shooting system, the operation apparatus has a display, and the image data obtained by the image shooting apparatus is displayed on the display through data communication. Image data is transmitted from the image shooting apparatus at regular time intervals, and the image displayed on the display of the operation apparatus is successively updated by receiving the image data. Consequently, the user can remotely operate the image shooting apparatus from the operation apparatus while viewing the image displayed on the display of the operation apparatus.

However, a communication data delay occurs in the data communication between the image shooting apparatus and the operation apparatus. For this reason, even if the user views an image displayed on the display of the operation apparatus and instructs the image shooting apparatus to record the image, because of a data delay, the condition of the image shooting apparatus is sometimes different from that at the time of the operation. Consequently, the image displayed at the time of the operation cannot be recorded, so that the image data desired by the user cannot be appropriately recorded.

Image data is sometimes compressed when transmitted from the image shooting apparatus to the operation apparatus. In this case, since time is also required for the compression and the restoration (decompression) performed at the operation apparatus, the image being taken by the image shooting apparatus is different from the image being displayed on the operation apparatus.

Further, when a data delay occurs in the case of an image shooting apparatus capable of changing the shooting direction or the like by performing an operation such as panning or tilting, even if the user instructs the image shooting apparatus to change the shooting direction, the change of the shooting direction is not reflected in the image displayed on the operation apparatus for a long time after the provision of the instruction. When this happens, it is considered that the user erroneously performs the operation to provide the instruction more times than necessary. In such a case, even if an image in the shooting direction desired by the user is displayed, an excessive operation with the shooting direction exceeding the one desired by the user is performed by the instruction providing operation performed more times than necessary thereafter.

Accordingly, the present invention is made in view of the above-mentioned problems, and an object thereof is to eliminate the influence of the data delay between the image shooting apparatus and the operation apparatus in the image shooting system.

### SUMMARY OF THE INVENTION

To attain the above-mentioned objects, an image shooting apparatus according to the present invention comprises: an image generator for shooting a subject and for generating image data; an index information generator for generating index information for identifying a shooting condition of the image generator at the time of image shooting by the image generator; a memory for storing a parameter representative of the shooting condition and the index information so as to be associated with each other; and a transmitter for transmitting the image data and the index information to an operation apparatus capable of controlling the image shooting apparatus.

To attain the above-mentioned objects, an operation apparatus according to the present embodiment comprises: an input member for inputting an operation command to control the image shooting apparatus; a receiver for receiving image data and index information associated with the image data from the image shooting apparatus; a display for displaying the received image data; and a transmitter for transmitting, when the operation command is input from the input member, the index information associated with the image data displayed on the display and a command corresponding to the operation command to the image shooting apparatus.

To attain the above-mentioned objects, another image shooting apparatus according to the present invention comprises: an image generator for shooting a subject and for generating image data; a transmitter for transmitting the image data to an operation apparatus capable of controlling the image shooting apparatus; a timer adjusted so as to indicate a time the same as a time at the operation apparatus; a receiver for receiving data from the operation apparatus; a comparator for comparing, when time information is included in the data received by the receiver, a time represented by the time information with the time indicated by the timer; and a controller for controlling the image shooting apparatus so as not to execute a command included in the data received from the operation apparatus for a predetermined time when there is a difference not less than a predetermined threshold value between the times as a result of the comparison by the comparator.

To attain the above-mentioned objects, another operation apparatus according to the present invention comprises: a timer adjusted so as to indicate a time the same as a time at the image shooting apparatus; an input member for inputting an operation command to control the image shooting apparatus; a transmitter for transmitting, when the operation command is input from the input member, a command corresponding to the operation command and information on the time represented by the timer to the image shooting apparatus.

According to the present invention, even when a data delay occurs, the index information for easily identifying the parameters representative of the shooting condition or the image data temporarily stored in the image shooting apparatus can be obtained on the operation apparatus. In addition, the influence of the data delay can be eliminated, so that the commands from the operation apparatus can be appropriately executed on the image shooting apparatus.

Moreover, when the time information is included in the received data, the image shooting apparatus compares the time represented by the time information with the time indicated by the timer. When the difference between the times is not less than a predetermined threshold value, the commands included in the data received from the operation apparatus are not executed for a predetermined time. Consequently, deterioration in operability due to a data delay can be improved.

In the following description, like parts are designated by like reference numbers throughout the several drawings.

### BRIEF DESCRIPTION OF THE DRAWINGS

FIG. 1 shows an example of the structure of an image shooting system according to embodiments of the present invention;

FIG. 2 shows the internal structure of an image shooting apparatus of a first embodiment;

FIG. 3 shows the internal structure of an operation apparatus of the first embodiment;

FIG. 4 shows an example of a condition where information comprising image data, the shooting time and the shooting parameters associated with one another is temporarily stored;

FIG. 5 shows the data transmission procedure in a case where image recording is performed in the first embodiment;

FIG. 6 shows the internal structure of an image shooting apparatus of a second embodiment;

FIG. 7 shows the internal structure of an operation apparatus of the second embodiment; and

FIG. 8 shows the data transmission procedure in a case where the shooting direction or the like is changed in the second embodiment.

### DETAILED DESCRIPTION OF THE PREFERRED EMBODIMENTS

Embodiments of the present invention will be described in detail with reference to the drawings.

<1. First Embodiment>

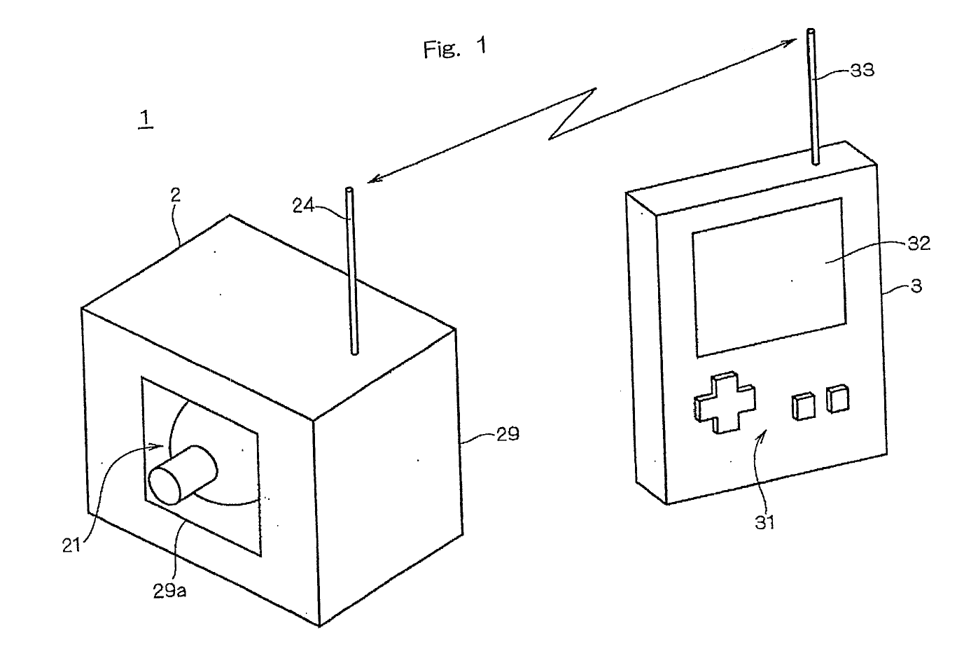

First, a first embodiment will be described. FIG. 1 shows an example of the structure of an image shooting system 1 according to the embodiments of the present invention. The image shooting system 1 comprises: an image shooting apparatus 2 for shooting images and generating image data; and an operation apparatus 3 capable of remotely operating the image shooting apparatus 2.

The image shooting apparatus 2 generates image data by photoelectrically converting light from the subject like a digital still camera or a digital movie camera. The image shooting apparatus 2 performs panning and tilting so that the shooting direction can be changed, and has a zoom lens system so that the shooting magnification can be changed. The image shooting apparatus 2 is provided with: a main body 29 incorporating circuitry as described later; an image shooting unit 21 disposed in a front part of the main body 29; and an antenna 24 for performing data communication with the operation apparatus 3. On the front side of the main body 29, an opening 29a is formed so that the image shooting unit 21 does not come into contact with the main body 29 when panning or tilting is performed. The image shooting unit 21 is placed inside the opening 29a.

The operation apparatus 3 comprises a portable telephone, a specifically designed operation terminal, a computer or the like, and is capable of performing wireless data communication with the image shooting apparatus 2 and of remotely operating the image shooting apparatus 2. The operation apparatus 3 is provided with the following in addition to circuitry incorporated in the main body: an operation input member 31 from which the user inputs commands to the image shooting apparatus 2; an image display 32 on which image display is performed based on the received image data; and an antenna 33 for performing data communication with the image shooting apparatus 2. The operation input member 31 comprises a plurality of operation buttons such as a preset button and a direction specifying button for driving the image shooting unit 21 in the panning direction or the tilt direction. The image display 32 comprises a liquid crystal display or the like.

While the data communication is wireless communication in the example of FIG. 1, it may be wire communication. Moreover, the data communication may take any of the following forms: a communication form via telephone lines; a communication form via the Internet; and a communication form where the image shooting apparatus 2 and the operation apparatus 3 directly perform data communication with each other.

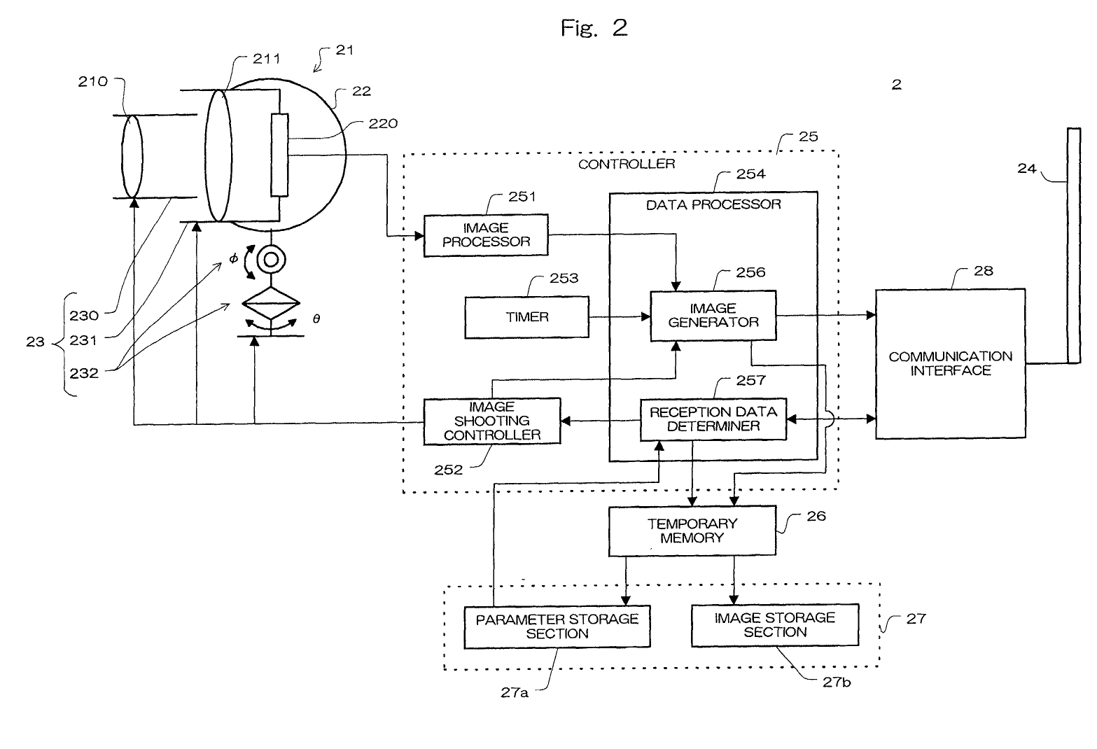

FIG. 2 shows the internal structure of the image shooting apparatus 2. The image shooting apparatus 2 is provided with the image shooting unit 21, a controller 25, a temporary memory 26, a data memory 27, a communication interface 28, and an antenna 24.

As shown in FIG. 2, the image shooting unit 21 of the image shooting apparatus 2 is provided with: a zoom lens system 210; a focusing lens system 211; a driver 23; a C CD image shooting sensor 220 photoelectrically converts the light image of the subject taken by the image shooting unit 21 into image signals of color components of R (red), G (green) and B (blue) (signals comprising a string of signals received at the pixels); and a spherical unit 22 containing these elements. The driver 23 is provided with: a first driver 230 driving the zoom lens system 210 to change the shooting magnification; a second driver 231 driving the focusing lens system 211 to adjust the focus position and driving the diaphragm to adjust the aperture; and a third driver 232 driving the spherical unit 22 for panning and tilting.

The third driver 232 is capable of imparting to the spherical unit 22 a rotation (θ rotation) of approximately ±70 degrees in the panning direction and an elevation (∅ rotation) of approximately ±70 degrees in the tilt direction. To impart the rotations in the panning and the tilt directions, the third driver 323 includes a plurality of piezoelectric elements. The driving by the first driver 230 for zooming is performed by piezoelectric elements other than the above-mentioned ones. By supplying sawtooth signals to the piezoelectric elements, the element to be driven by the piezoelectric elements is inched, and by repeating this, a required motion is imparted to the element to be driven. The driving mechanisms of the drivers 230 and 232 are not limited to the ones using piezoelectric elements, but other kinds of driving mechanisms such as one using a small-size motor or the like may be adopted.

The controller 25 is implemented, for example, as a CPU, and by the CPU performing predetermined programs, functions as an image processor 251, an image shooting controller 252, a timer 253 and a data processor 254 are implemented. The data processor 254 processes transmission data to or reception data from the operation apparatus 3, and functions as an image generator 256 and a reception data determiner 257.

The image processor 251 performs predetermined image processings such as color correction and pixel interpolation on the image signals obtained from the image shooting unit 21, and generates image data.

The image shooting controller 252 provides the driver 23 with a driving command to control conditions such as the shooting direction, the shooting magnification, the focus position and the aperture of the image shooting unit 21. The image shooting controller 252 also provides the information generator 256 with shooting parameters associated with the current panning position, tilt position, zoom position and focus position of the image shooting unit 21.

The timer 253 is implemented as a real-time clock circuit, and the time information thereof is supplied to the information generator 256 at the timing at which the image data is generated at the image shooting apparatus 2.

The information generator 256 functions when image data is transmitted to the operation apparatus 3. When image data is input from the image processor 251, the information generator 256 performs resolution reduction, thinning-out and the like on the image data so that the image data is reduced in amount. The information generator 256 enciphers the image data as required. When image data is input from the image processor 251, the information generator 256 obtains the shooting time of the image data from the timer 253, and obtains shooting parameters from the image shooting controller 252. Then, the information generator 256 generates information comprising high-resolution image data, that is, image data not reduced in amount, the shooting time and the shooting parameters associated with one another, and stores the information into the temporary memory 26. The shooting time serves as index information for identifying the high-resolution image data and the shooting parameters.

The temporary memory 26 comprises a RAM or the like, and temporarily stores the information comprising the image data, the shooting time and the shooting parameters associated with one another until a predetermined time elapses. Thus, in the temporary memory 26, the following are stored: the image data obtained by the image shooting unit 21; the time when the image data is taken; and the conditions of the image shooting unit 21 under which the image data is taken.

The information generator 256 also generates transmission data from the shooting time and the image data reduced in amount, and supplies it to the communication interface 28.

The communication interface 28 has a function of performing data communication with the operation apparatus 3, and transmits the transmission data supplied from the information generator 256 to the operation apparatus 3 through the antenna 24. The communication interface 28 also functions as means for receiving the data from the operation apparatus 3, and supplies the reception data obtained from the operation apparatus 3 to the reception data determiner 257 of the data processor 254.

The reception data determiner 257 functions when the reception data is input from the communication interface 28, and performs a processing corresponding to the command included in the reception data. Particularly, in the present embodiment, when the shooting time is included in the reception data, using the shooting time included in the reception data as the index information, the reception data determiner 257 accesses the temporary memory 26, and records the image data stored in the temporary memory 26 into the data memory 27. The reception data determiner 257 instructs the image shooting controller 252 to change the shooting direction, the shooting magnification and the like of the image shooting unit 21 based on the shooting parameters stored in the temporary memory 26.

The data memory 27 comprises a memory card having a semiconductor memory such as a flash memory, a magnetic disk unit or the like, and is capable of holding data for a long time. The data memory 27 has a parameter storage section 27a and an image storage section 27b. In the parameter storage section 27a, the shooting parameters associated with the panning position, the tilt position, the zoom position and the focus position are stored as the preset positions for the image shooting unit 21. In the image storage section 27b, image data for recording is stored.

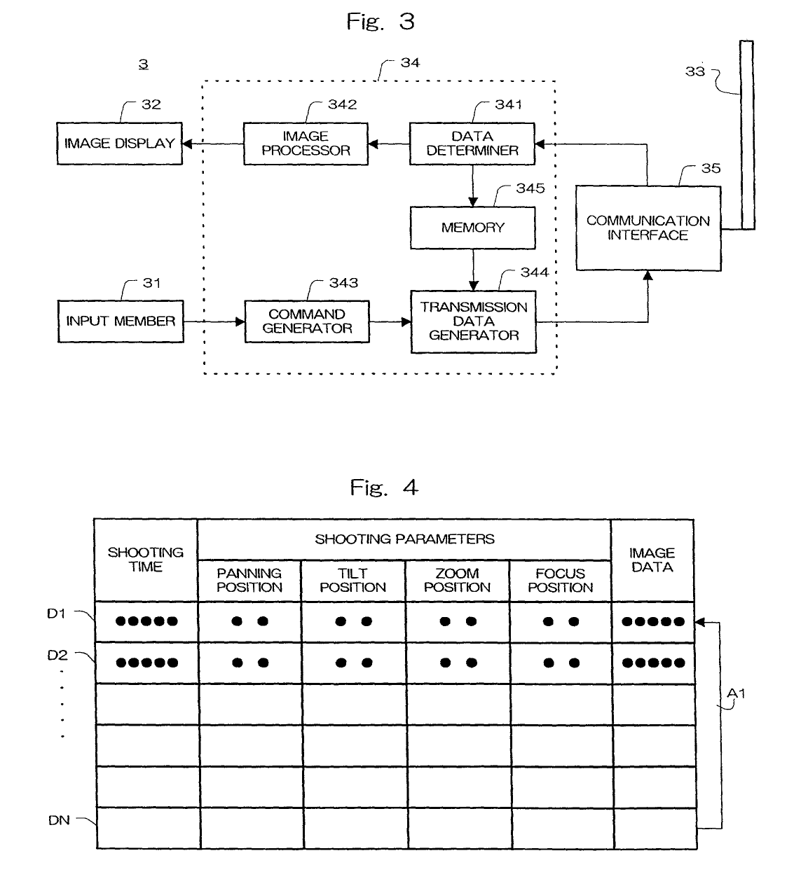

FIG. 3 shows the internal structure of the operation apparatus 3. The operation apparatus 3 has as the internal structure a controller 34 and a communication interface 35 as well as the above-described operation input member 31, image display 32 and antenna 33. The controller 34 is implemented, for example, as a CPU, and by the CPU performing predetermined programs, functions as a data determiner 341, an image processor 342, a command generator 343, a transmission data generator 344 and a memory 345 are implemented.

The data received by the antenna 33 is supplied to the data determiner 341 through the communication interface 35 having a transmission function and a reception function.

Receiving the data transmitted from the image shooting apparatus 2, the data determiner 341 distinguishes the shooting time from the image data, stores the information on the shooting time into the memory 345, and supplies the image data to the image processor 342. The image processor 342 performs predetermined processing (for example, decompression of compressed data) on the image data, and then, supplies the image data to the image display 32 to display the image taken by the image shooting apparatus 2. This image display enables the user to confirm the image taken by the image shooting apparatus 2.

When the user inputs an operation command to the image shooting apparatus 2 from the operation input member 31, the command generator 343 generates a command corresponding to the operation command, and supplies it to the transmission data generator 344.

Examples of the command corresponding to the operation command include a shooting command to start shooting, a recording command to record image data, a request command to request for transmission of high-resolution image data and a control command to control the shooting direction, the shooting magnification and the like of the image shooting unit 21. The control command includes: a first driving command to start driving of each part of the image shooting unit 21 in the specified driving direction to change the shooting direction, the shooting magnification and the like; a second driving command to drive the image shooting unit 21 to set the conditions such as the shooting direction and the shooting magnification to those under which the displayed image is taken; a setting command to set the preset positions of the image shooting unit 21 such as the shooting direction and the shooting magnification; and a third driving command to drive the image shooting unit 21 to the preset positions.

Receiving the command from the command generator 343, the transmission data generator 344 obtains the shooting time stored in the storage section 345, and adds the shooting time to the command to generate transmission data. The transmission data is supplied to the communication interface 35, and transmitted to the image shooting apparatus 2 through the antenna 33.

Next, the operation of each part performed when image data is transmitted from the image shooting apparatus 2 and the user operates the image shooting apparatus 2 from the operation apparatus 3 in the image shooting system 1 structured as described above will be described in detail.

First, the user performs an image shooting start operation on the operation apparatus 3. Then, the shooting command is generated at the operation apparatus 3, and is transmitted from the operation apparatus 3 to the image shooting apparatus 2. In the initial stage at this time, since the shooting time is not stored in the storage section 345 of the operation apparatus 3, only the shooting command is transmitted as the transmission data. Receiving the shooting command, the image shooting apparatus 2 starts image shooting by the image shooting unit 21, and generates image data at predetermined time intervals. At the controller 25 of the image shooting apparatus 2, every time image data is obtained from the image shooting unit 21, information comprising the image data, the shooting time and the shooting parameters associated with one another is stored in the temporary memory 26.

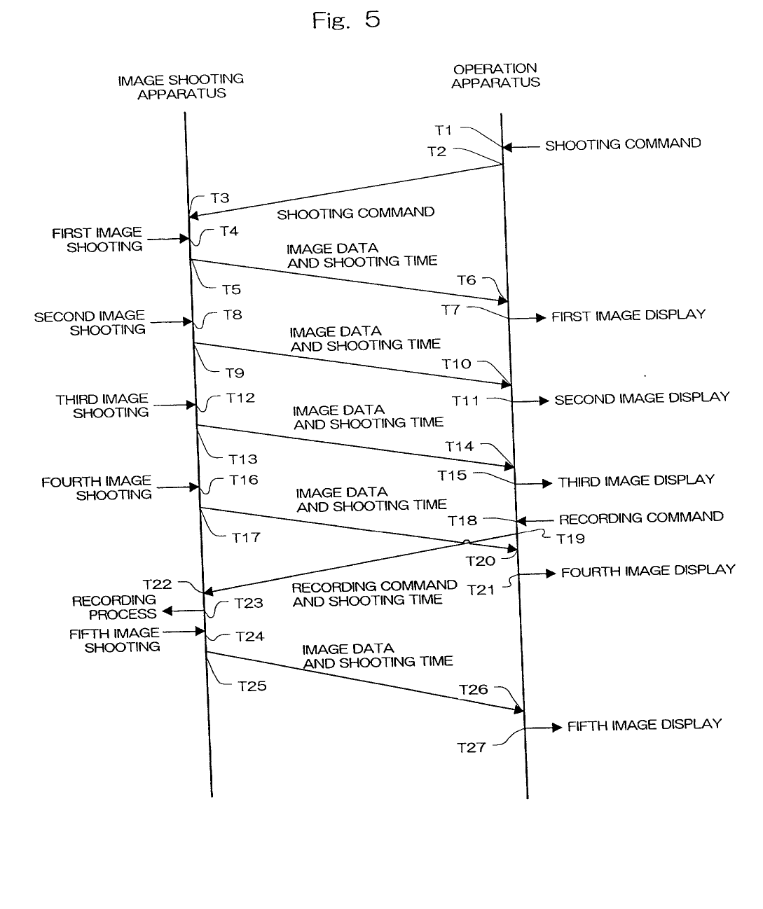

FIG. 4 shows an example of a condition where the information comprising the image data, the shooting time and the shooting parameters associated with one another is stored in the temporary memory 26. The information generator 256 successively generates information D1, information D2, . . . and information DN comprising the image data and the like associated with one another every time one frame of image data is obtained from the image shooting unit 21, and successively adds them into the temporary memory 26.

The information generator 256 compares the current time obtained from the timer 253 with the shooting time of the information stored in the temporary memory 26, and erases from the temporary memory 26 the information on the shooting time from which a predetermined time has elapsed. Here, the predetermined time is preset to a time with in which, for example, even in a case where the worst data delay occurs between the image shooting apparatus 2 and the operation apparatus 3, when an operation input for the displayed image is made on the operation apparatus 3, the command can be received.

Since the capacity of the temporary memory 26 is limited, when the temporary memory 26 is full of information, even if the predetermined time has not elapsed, the information generator 256 stores the newly generated information in, of the areas of the temporary memory 26 in which information is stored, the area in which the oldest information is stored. For example, the information D1, the information D2, . . . are successively stored into the temporary memory 26, and when the temporary memory 26 becomes full when the information DN is stored, as shown by the arrow A1 of FIG. 4, the next information stored area is set to the area in which the oldest information D1 is stored. After the information D1 is erased, the next information is stored in the area. This applies to the succeeding information storage.

While four pieces of information, the panning position, the tilt position, the zoom position and the focus position, are stored as the shooting parameters in the example shown in FIG. 4, information on the aperture condition and the exposure time may be included as well. The image data stored in the temporary memory 26 is image data obtained from the image processor 251 which data is high-resolution image data not reduced in amount.

The information generator 256 generates image data reduced in amount every time one frame of image data is obtained, and successively transmits the shooting time at which the image data is taken and the image data reduced in amount to the operation apparatus 3. Consequently, the operation apparatus 3 repetitively receives image data.

The operation apparatus 3 updates the image displayed on the image display 32 based on the successively obtained image data, and updates the shooting time stored in the storage section 345. That is, every time image data is received, the controller 34 stores the latest shooting time included in the reception data into the storage section 345, and performs image display based on the latest image data. By doing this, the time at which the image data to be displayed on the operation apparatus 3 is taken can be stored in the storage section 345.

Visually confirming the image displayed on the operation apparatus 3, the user makes an operation input such as an image recording instruction when a desired image is displayed. In response to the operation input, the controller 34 generates a command corresponding to the operation command such as the recording command, and obtains from the storage section 345 the time at which the image displayed at that time is taken. Then, the operation apparatus 3 transmits data comprising the command and the shooting time associated with each other to the image shooting apparatus 2. However, when the command is the first driving command or the third driving command, it is unnecessary to associate the command with the shooting time.

When the image shooting apparatus 2 receives the data from the operation apparatus 3, the reception data determiner 257 analyzes the command. Moreover, using the shooting time included in the reception data as the index information, the reception data determiner 257 accesses the temporary memory 26, and identifies the information having the same shooting time as that included in the reception data.

When the command is the recording command, the reception data determiner 257 extracts the high-resolution image data from the identified information, and stores the high-resolution image data into the image storage section 27b of the data memory 27. By doing this, the image desired by the user can be recorded in the image shooting apparatus 2.

When the command is the request command to request for high-resolution image data, the reception data determiner 257 extracts the high-resolution image data from the identified information, outputs it to the communication interface 28, and transmits it to the operation apparatus 3. By doing this, the operation apparatus 3 can obtain the high-resolution image data desired by the user.

When the command is the first driving command, to drive the image shooting unit 21 in the driving direction specified by the command, the reception data determiner 257 provides the image shooting controller 252 with a command to start the driving of the image shooting unit 21 by the driver 23. Consequently, the image shooting unit 21 performs panning or tilting at a predetermined speed. During the panning or tilting, image shooting is repeated, and image data is successively transmitted from the image shooting apparatus 2.

When the command is the second driving command, the reception data determiner 257 extracts the shooting parameters from the identified information, and supplies the shooting parameters to the image shooting controller 252. The image shooting controller 252 generates a control signal for driving the image shooting unit 21 to the panning position, the tilt position, the zoom position and the focus position shown by the shooting parameters, and drives the driver 23. This brings the image shooting unit 21 into a condition the same as the condition under which the image displayed at the time when the user operates the operation apparatus 3 is taken, which enables image shooting under the shooting condition desired by the user. Consequently, an overrun due to a data delay can be corrected, that is, the condition change amount (movement amount) during the data delay can be resolved when the shooting condition at the image shooting unit 21 is being changed such as when the image shooting unit 21 is being moved in the panning direction or the tilt direction or when the zoom lens system 210 is being driven.

When the command is the setting command, the reception data determiner 257 extracts the shooting parameters from the identified information, and records the shooting parameters into the parameter storage section 27a of the data memory 27 to register them as the preset positions. By doing this, when the third driving command is received in the image shooting apparatus 2, the image shooting unit 21 can be driven to the preset positions prespecified by the user. For example, there are cases where the user wants to return the shooting direction of the image shooting unit 21 to the original one after changing it, and in such cases, by presetting the preset positions, the shooting direction of the image shooting unit 21 can be returned to the original one only by operating the preset button of the operation apparatus once.

FIG. 5 shows the data transmission procedure in a case where image recording is performed in the first embodiment. In this figure, time elapses toward the bottom of the figure.

When the user supplies an operation command to start image shooting to the operation apparatus 3, in response thereto, the shooting command is generated at a time T1. The shooting command is transmitted from the operation apparatus 3 at a time T2. The shooting command is received by the image shooting apparatus 2 at a time T3.

At the image shooting apparatus 2, image shooting is started in response to the reception of the shooting command. A first image is taken and first image data is generated at a time T4. Then, the first image data and information on the shooting time (T4) of the first image are transmitted from the image shooting apparatus 2 to the operation apparatus 3 at a time T5.

At the operation apparatus 3, the first image data and the shooting time are received at a time T6, and the first image is displayed based on the received image data at a time T7.

At the image shooting apparatus 2, image shooting is repeated at predetermined time intervals by the shooting command. Second image data is generated at a time T8, and the second image data and information on the shooting time (T8) of the second image are transmitted from the image shooting apparatus 2 to the operation apparatus 3 at a time T9. Thereafter, third, fourth and fifth image data are generated at times T12, T16 and T24, and the image data and the shooting time thereof (T12, T16, T24) are transmitted at times T13, T17 and T25. By the image data being successively transmitted from the image shooting apparatus 2, at the operation apparatus 3, the image data and the shooting times thereof (T8, T12, T16, T24) are received at times T10, T14, T20 and T26, and the images are displayed at times T11, T15, T21 and T27.

For example, in a case where the user performs an image recording operation at the time (T15) when image display based on the third image data is performed at the operation apparatus 3 as shown in FIG. 5, the recording command is generated at T18 at the operation apparatus 3. Then, the operation apparatus 3 transmits the recording command and data including the shooting time (T12) of the third image to the image shooting apparatus 2 at a time T19.

The recording command is received by the image shooting apparatus 2 at a time T22 when the shooting and transmission of the fourth image have already been finished. However, in the image shooting system 1, since the image data and the like taken by that time are temporarily stored in the temporary memory 26, the image data to be recorded can be extracted from the temporary memory 26 by searching the temporary memory 26 based on the shooting time (T12) included in the data received at the time T22. Consequently, the image shooting apparatus 2 can appropriately store the image data desired by the user by recording process the third image data at a time T23.

That is, even when a data delay occurs between the image shooting apparatus 2 and the operation apparatus 3, the image data displayed on the operation apparatus 3 when the user provide an instruction to record the image can be easily identified at the image shooting apparatus 2, and the image data can be appropriately recorded.

While a case where recording is performed is shown as an example in the description given above, the same applies to cases where other commands are transmitted.

For example, when the first driving command is transmitted to the image shooting apparatus 2 together with the shooting command in FIG. 5, the first, the second and the third images are successively taken while an operation such as panning, tilting or zooming is performed at the image shooting apparatus 2. Then, by the user performing an operation to set the shooting condition to the condition under which the displayed image is taken at the time (T18) when the third image is displayed, the second driving command is generated. Then, the second driving command is transmitted to the image shooting apparatus 2 together with the shooting time (T12) of the third image data. The image shooting unit 21 of the image shooting apparatus 2 performs an operation such as panning, tilting or zooming during that time, and since the shooting parameters with which the third image data is taken can be identified from the shooting time (T12) received from the operation apparatus 3, after the second driving command is received, the image shooting unit 21 is driven based on the identified shooting parameters. By doing this, the movement amount of an overrun of the image shooting unit 21 that occurs between the time (T12) when the third image is taken and the time (T22) when the second driving command is received can be resolved.

When the setting command is generated at the time T18, the preset positions are set based on the shooting parameters with which the third image data is taken.

As described above, in the image shooting system 1 of the present embodiment, the image shooting apparatus 2 obtains the shooting time at the time of image shooting as the index information for identifying the shooting condition or the image data. Then, the parameters representative of the shooting condition or the image data is stored in the temporary memory 26 so as to be associated with the shooting time, and the image data and the shooting time are transmitted to the operation apparatus 3. When the data received from the operation apparatus 3 includes the shooting time, the image shooting apparatus 2 obtains parameters or image data stored in the temporary memory 26 based on the received information on the shooting time, and performs processing.

When image data is received from the image shooting apparatus 2, the operation apparatus 3 performs image display based on the image data. In addition, when an operation command is input by the user, the operation apparatus 3 transmits the shooting time received together with the image data to be displayed to the image shooting apparatus 2 together with a command corresponding to the operation command.

Consequently, since the image shooting apparatus 2 can identify the shooting condition or the image data which the command received from the operation apparatus 3 is issued for, the data delay between the image shooting apparatus 2 and the operation apparatus 3 can be resolved, so that commands from the operation apparatus 3 can be appropriately executed at the image shooting apparatus 2.

An example of usage of the image shooting system 1 is to observe the internal condition of the user's house during the absence of the user. In this usage, if the user can obtain the shooting time for identifying the image data or the like with the operation apparatus 3 while he is out, he can directly operate the image shooting apparatus 2 after he comes home. That is, it is considered to directly perform on the image shooting apparatus 2 an operation to record specific one of the image data stored in the temporary memory 26. Therefore, in this usage, it is unnecessary for the image shooting apparatus 2 to be provided with a function of receiving data from the operation apparatus 3.

However, for example, when the image shooting apparatus 2 is set in a place where the user cannot easily handle it such as in a place too high for the user to reach, it is desirable that the image shooting system 1 be structured so as to perform two-way communication as described in the present embodiment, and it is desirable that the image shooting apparatus 2 be structured so as to obtain, when receiving data from the operation apparatus 3, parameters or image data stored in the temporary memory 26 based on the received information on the shooting time and perform predetermined processing.

While in the present embodiment, the shooting time of the image is used as the index information for identifying the shooting condition at the image shooting unit 21 or the image data obtained from the image shooting unit 21, the present invention is not limited thereto. For example, serial numbers corresponding to the order in which images are taken may be adopted as the index information, or the shooting parameters of the image shooting unit 21 may be adopted as the index information. The use of the shooting parameters as the index information is effective when the image shooting unit 21 is driven and image shooting is repetitively performed while the shooting direction, the shooting magnification or the like is changed.

<2. Second Embodiment>

Next, a second embodiment will be described. In the second embodiment, an example will be described in which when a data delay occurs and the user performs an operation more times than necessary, unnecessary operations at the image shooting apparatus 2 are reduced to thereby improve the operability.

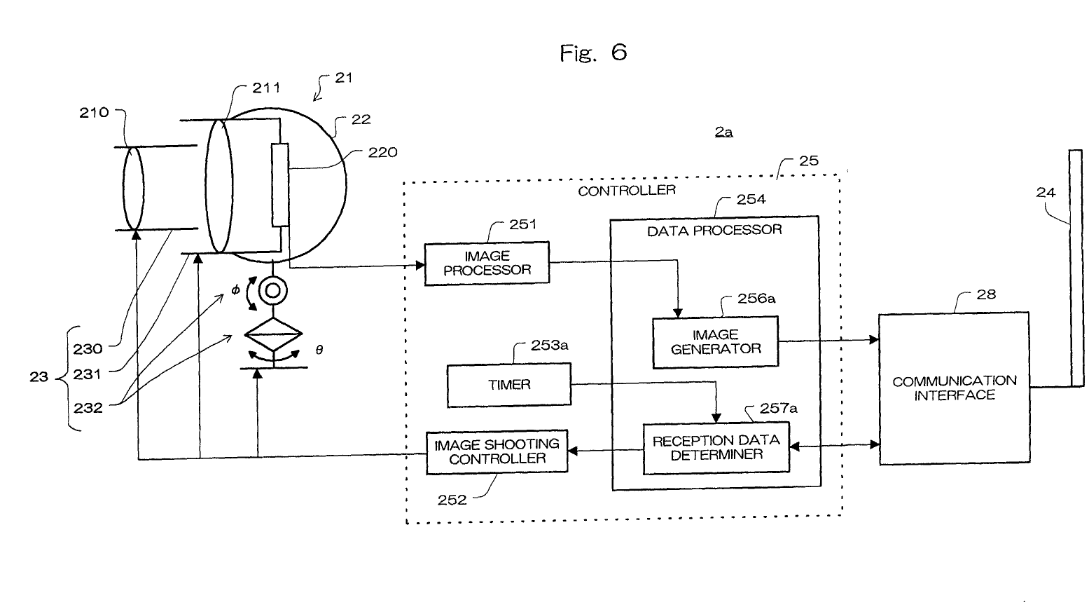

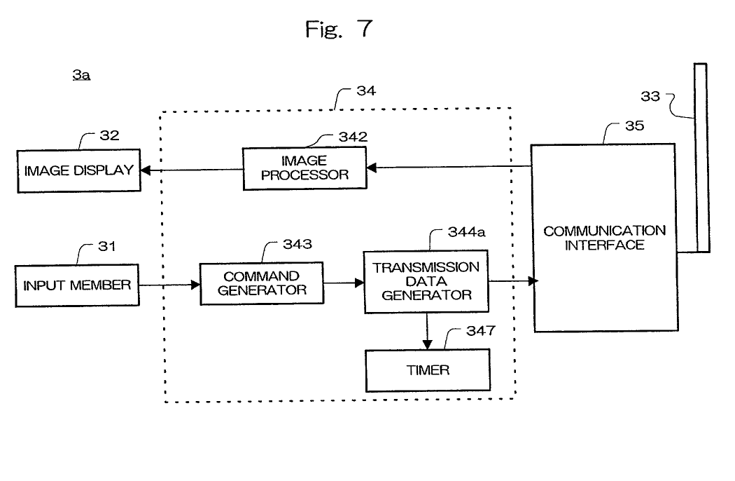

The general structure of the image shooting system of the present embodiment is similar to that shown in FIG. 1. FIG. 6 shows the internal structure of an image shooting apparatus 2a of the second embodiment. FIG. 7 shows the internal structure of an operation apparatus 3a of the second embodiment. In FIGS. 6 and 7, similar elements to those described in the first embodiment are denoted by the same reference numbers, and detailed descriptions thereof are omitted.

The image shooting apparatus 2a has the image shooting unit 21, the controller 25, the communication interface 28 and the antenna 24. The data processor 254 of the controller 25 processes transmission data or reception data to or from the operation apparatus 3a, and functions as an information generator 256a and a reception data determiner 257a. A timer 253a of the controller 25 is implemented as a real-time clock circuit, is set so as to indicate the same time as a timer 347 provided in the operation apparatus 3a, and supplies time information to the reception data determiner 257a.

The information generator 256a functions when image data is transmitted to the operation apparatus 3a. When image data is input from the image processor 251, the information generator 256a performs resolution reduction, thinning-out and the like on the image data so that the image data is reduced in amount. The information generator 256 enciphers the image data as required. The information generator 256a supplies the image data reduced in amount to the communication interface 28 to transmit the image data to the operation apparatus 3a.

The reception data determiner 257a functions when the reception data is input from the communication interface 28, and performs processing corresponding to the command included in the reception data. Particularly, in the present embodiment, when the time information of the operation apparatus 3a is included in the reception data, the reception data determiner 257a compares the time information obtained from the timer 253a with the time information included in the reception data, and determines whether the difference between the times is not less than a predetermined threshold value or not. When the difference is not less than the predetermined threshold value, the commands received from the operation apparatus 3a thereafter are not executed for a predetermined time.

The operation apparatus 3a has the operation input member 31, the image display 32, the controller 34, the communication interface 35 and the antenna 33. The controller 34 functions as the image processor 342, the command generator 343, a transmission data generator 344a and the timer 347.

The timer 347 is implemented as a real-time clock circuit, is set so as to indicate the same time as the timer 253a provided in the image shooting apparatus 2a, and supplies time information to the transmission data generator 344a.

The image data received by the antenna 33 is supplied to the image processor 342 through the communication interface 35 having a transmission function and a reception function. After predetermined processing (for example, decompression of compressed data) is performed on the image data at the image processor 342, the image is displayed on the image display 32.

When the user inputs an operation command to the image shooting apparatus 2a from the operation input member 31, the command generator 343 generates a command corresponding to the operation command, and supplies it to the transmission data generator 344a.

Receiving the command from the command generator 343, the transmission data generator 344a obtains the time information from the timer 347, and adds the time information to the command to generate transmission data. The transmission data is supplied to the communication interface 35, and transmitted to the image shooting apparatus 2a through the antenna 33. Thus, the transmission data from the operation apparatus 3a includes the transmission time together with the command corresponding to the operation command.

Next, the operation of each part performed when image data is transmitted from the image shooting apparatus 2a and the user operates the image shooting apparatus 2a from the operation apparatus 3a in the image shooting system structured as described above will be described in detail.

First, the user performs an operation to start image shooting on the operation apparatus 3a. Then, the shooting command is generated at the operation apparatus 3a, and is transmitted from the operation apparatus 3a to the image shooting apparatus 2a. Receiving the shooting command, the image shooting apparatus 2a starts image shooting by the image shooting unit 21, and generates image data at predetermined time intervals. Every time one frame of image data is obtained, the information generator 256a generates image data reduced in amount, and the image data reduced in amount is successively transmitted to the operation apparatus 3a.

The operation apparatus 3a updates the image displayed on the image display 32 based on the successively transmitted image data. When the user wants to change the shooting direction, the shooting magnification or the like of the image shooting unit 21, he makes an operation input such as a shooting direction changing instruction at an arbitrary timing. In response to the operation input, the controller 34 generates a command corresponding to the operation command such as the first driving command, and obtains the time information, at that time, of the timer 347. Then, the operation apparatus 3a transmits data comprising the command and the time information associated with each other to the image shooting apparatus 2a.

When the image shooting apparatus 2a receives the data from the operation apparatus 3a, the reception data determiner 257a analyzes the command, and analyzes the difference between the transmission time at the operation apparatus 3a and the current time at the image shooting apparatus 2a. When not less than a predetermined time has elapsed since the transmission of the command by the operation apparatus 3a, on the presumption that a significant data delay occurs, the commands received from the operation apparatus 3a within a predetermined time thereafter are not executed but ignored.

When a significant data delay occurs, since the displayed image is not changed at all even though the user performs an operation to change the shooting direction on the operation apparatus 3a, it is presumed that the user repeats the operation input. Therefore, in the present embodiment, when it is presumed that a significant data delay occurs, the commands received from the operation apparatus 3a within a predetermined time thereafter are ignored to thereby prevent the commands based on unnecessary operation commands from being on standby.

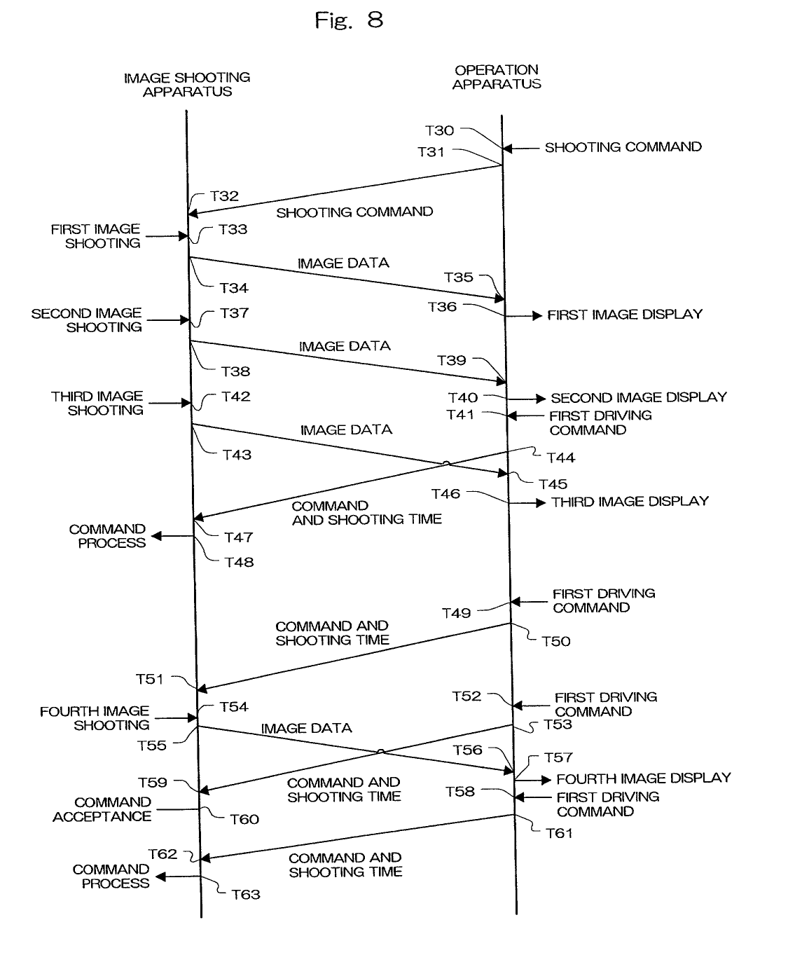

FIG. 8 shows the data transmission procedure in a case where the shooting direction or the like is changed in the second embodiment. In this figure, time elapses toward the bottom of the figure.

When the user supplies an operation command to start image shooting to the operation apparatus 3a, in response thereto, the shooting command is generated at a time T30. The shooting command is transmitted from the operation apparatus 3a at a time T31. The shooting command is received by the image shooting apparatus 2a at a time T32.

At the image shooting apparatus 2a, in response to the reception of the shooting command, continuous image shooting is started, image shooting is performed at times T33, T37 and T42, and first, second and third image data are generated at the times. Then, the image data is transmitted from the image shooting apparatus 2a to the operation apparatus 3a at times T34, T38 and T43. At the operation apparatus 3a, the image data are received at times T35, T39 and T45, and the images are displayed at times T36, T40 and T45.

For example, when the user makes an operation input to change the shooting direction of the image shooting unit 21 at the time (T40) when the second image is displayed on the operation apparatus 3a, the first driving command is generated at a time T41, and the first driving command and the time information (T44) at the operation apparatus 3a are transmitted at a time T44. If it is assumed that a data delay occurs at that time, the transmission data from the operation apparatus 3a is received by the image shooting apparatus 2a at a time T47.

However, at the operation apparatus 3a, the third image data is received and the third image is displayed after the user makes the operation input. Since the third image is taken under a condition in which the operation input by the user is not reflected, it is presumed that the user considers that the command processing by the operation input is not normally performed and makes the same operation input again at times T49 and T52. The commands based on the same operation input are transmitted from the operation apparatus 3a at times T50 and T53, and received by the image shooting apparatus 2a at times T51 and T59.

At the image shooting apparatus 2a, when the data from the operation apparatus 3a is received at the time T47, the command processing is started at a time T48. At this time, the image shooting apparatus 2a compares the transmission time (T44) included in the received data with the current time (T48) at the image shooting apparatus 2a, and determines whether the difference between the times (T48−T44) is not less than a predetermined threshold value or not. When it is presumed that a significant data delay occurs as a result of the determination, the image shooting apparatus 2a ignores the commands received from the operation apparatus 3a within a predetermined time thereafter. However, the processing associated with the first driving command received at the time T47 is executed.

In the example of FIG. 8, it is determined that the difference (T48−T44) is not less than the predetermined threshold value, the processing of the received first driving command is started at the time T48, and the commands received between the times T48 and T60 are ignored. Consequently, the first driving commands transmitted from the operation apparatus 3a at the times T50 and T53 are ignored at the image shooting apparatus 2a, and are never on standby.

During the predetermined time, after the command processing started at the time T48 is performed, a fourth image is taken at the image shooting apparatus 2a (time T54). The fourth image data is transmitted from the image shooting apparatus 2a to the operation apparatus 3a at the time T55. At the operation apparatus 3a, the fourth image data is received at a time T56, and image display based on the fourth image data is performed at a time T57. At the image shooting apparatus 2a, the commands input by that time (time T57) (commands input at the times T49 and T52) are ignored, and no command is on standby. That is, the fourth image displayed on the operation apparatus 3a is an image where the command processing is completed.

The user confirms the fourth image and inputs a command at a time T58. At the image shooting apparatus 2a, the predetermined time is set so that command acceptance (time T60) is started with the command transmitted at this time. By doing this, the command that the user inputs after confirming the image taken when the processing is completed can be appropriately executed, and the excessive execution processing based on the excessive command inputs made by that time can be prevented. Consequently, the command that the user inputs after confirming the image taken when the processing is completed can be quickly executed.

That is, since the transmission data of which operation input is made at the time T58 at the operation apparatus 3a and that is transmitted at a time T61 is received by the image shooting apparatus 2a at a time T62 after the lapse of the command acceptance stopped period (T48 to T60), the command processing corresponding to the command is immediately and appropriately performed (time T63). At the time T63, comparison of the transmission time (T61) included in the received data with the current time (T63) at the image shooting apparatus 2a is performed as well as the command processing, and it is determined whether the difference between the times (T63−T61) is not less than a predetermined threshold value or not. When the difference is not less than the predetermined threshold value, the commands received from the operation apparatus 3a within a predetermined time thereafter are ignored, and when the difference is less than the predetermined threshold value, the image shooting apparatus 2a performs similar command processing and time difference evaluation with respect to the data received thereafter.

Since the actual communication delay time always changes, the command input before the fourth image is displayed on the operation apparatus 3 is sometimes received by the image shooting apparatus 2a. However, since the commands received by the image shooting apparatus 2a can be ignored at least within the predetermined time, excessive command inputs can be reduced.

In the image shooting system of the present embodiment, when a data delay occurs between the image shooting apparatus 2a and the operation apparatus 3a and the data delay is significant, the commands that the image shooting apparatus 2a receives from the operation apparatus 3a within a predetermined time are not executed. Consequently, the situation can be resolved that a multiplicity of commands are on standby and the condition desired by the user is not realized at all. That is, deterioration in operability that occurs when the data delay is significant can be reduced.

It is desirable that the time for which the commands from the operation apparatus 3a are ignored be changed according to the kind of the command executed at that time. For example, when the command is the first driving command, the predetermined time may be set so that the commands from the operation apparatus 3a are ignored until the driving of the image shooting unit 21 in the specified driving direction is finished.

While in the present embodiment, an example is shown in which when a data delay occurs between the image shooting apparatus 2a and the operation apparatus 3a and the data delay is significant, the commands that the image shooting apparatus 2a receives from the operation apparatus 3a within a predetermined time are not executed, the structure in the present embodiment may be provided in juxtaposition with the structure shown in the first embodiment.

<3. Modification>

While the embodiments of the present invention have been described, the present invention is not limited to the above-described embodiments.

For example, while the series of processings at each part of the image shooting apparatus 2 and 2a and the operation apparatus 3 and 3a are implemented as software processings by a CPU in the examples described above, some or all of the processings may be implemented by a circuit specifically designed therefor.

Although the present invention has been fully described by way of examples with reference to the accompanying drawings, it is to be noted that various change and modifications will be apparent to those skilled in the art. Therefore, unless otherwise such changes and modifications depart from the scope of the present invention, they should be construed as being including therein.

What is claimed is:

1. An image shooting apparatus comprising:
an image generator for shooting a subject and for generating image data;
an index information generator for generating index information for identifying a shooting condition of the image generator at the time of image shooting by the image generator;
a memory for storing a parameter representative of the shooting condition and the index information so as to be associated with each other; and
a transmitter for transmitting the image data and the index information to an operation apparatus capable of controlling the image shooting apparatus.

2. An image shooting apparatus according to claim 1, further comprising:
a receiver for receiving data from the operation apparatus; and
a controller for obtaining, when the index information is included in the data received by the receiver, the parameter stored in the memory based on the received index information, and for performing process based on the obtained parameter.

3. An image shooting apparatus according to claim 2, further comprises a driver for driving the image generator to change a shooting direction or a shooting magnification of the image generator, and when a command associated with the driving of the image generator and the index information are included in the data received by the receiver, the controller obtains the parameter based on the index information, and drives the driver based on the obtained parameter.

4. An image shooting apparatus according to claim 1, wherein the index information is the shooting time at which the image generator performs image shooting.

5. An image shooting apparatus comprising:
an image generator for shooting a subject and for generating image data;
an index information generator for generating index information for identifying the image data at the time of image shooting by the image generator;
a first memory for storing the image data and the index information so as to be associated with each other; and
a transmitter for transmitting the image data and the index information to an operation apparatus capable of controlling the image shooting apparatus.

6. An image shooting apparatus according to claim 5, further comprising:
a receiver for receiving data from the operation apparatus; and
a controller for obtaining, when the index information is included in the data received by the receiver, the image data stored in the first memory based on the received index information, and for performing process of the obtained image data.

7. An image shooting apparatus according to claim 2, further comprises a second memory different from the first memory and the controller stores the image data stored in the first memory into the second memory based on the received index information.

8. An image shooting apparatus according to claim 5, wherein the index information is the shooting time at which the image generator performs image shooting.

9. An operation apparatus capable of controlling an image shooting apparatus, comprising:
an input member for inputting an operation command to control the image shooting apparatus;
a receiver for receiving image data and index information associated with the image data from the image shooting apparatus;
a display for displaying the received image data; and
a transmitter for transmitting, when the operation command is input from the input member, the index information associated with the image data displayed on the display and a command corresponding to the operation command to the image shooting apparatus.

10. An operation apparatus according to claim 9, wherein the operation command is a command to cause the image shooting apparatus to record the image data displayed on the display.

11. An operation apparatus according to claim 9, wherein the operation command is a command to cause the image shooting apparatus to change a shooting direction or a shooting magnification.

12. An operation apparatus according to claim 9, wherein the index information is the shooting time at which the image generator performs image shooting.

13. An image shooting apparatus comprising:
an image generator for shooting a subject and for generating image data;
a transmitter for transmitting the image data to an operation apparatus capable of controlling the image shooting apparatus;
a timer adjusted so as to indicate a time the same as a time at the operation apparatus;
a receiver for receiving data from the operation apparatus;
a comparator for comparing, when time information is included in the data received by the receiver, a time represented by the time information with the time indicated by the timer; and
a controller for controlling the image shooting apparatus so as not to execute a command included in the data received from the operation apparatus for a predetermined time when there is a difference not less than a predetermined threshold value between the times as a result of the comparison by the comparator.

14. An operation apparatus capable of controlling an image shooting apparatus, comprising:
a timer adjusted so as to indicate a time the same as a time at the image shooting apparatus;
an input member for inputting an operation command to control the image shooting apparatus;
a transmitter for transmitting, when the operation command is input from the input member, a command corresponding to the operation command and information on the time represented by the timer to the image shooting apparatus.
